(19) United States
(12) Patent Application Publication
(10) Pub. No.: US 2015/0341832 A1
(43) Pub. Date: Nov. 26, 2015

(54) MOBILITY ROBUSTNESS OPTIMIZATION FOR HETEROGENEOUS AND SMALL CELL NETWORKS

(71) Applicant: QUALCOMM Incorporated, San Diego, CA (US)

(72) Inventors: Insoo Hwang, San Diego, CA (US); Soumya Das, San Diego, CA (US); Samel Celebi, Summit, NJ (US); Bongyong Song, San Diego, CA (US)

(73) Assignee: QUALCOMM Incorporated, San Diego, CA (US)

(21) Appl. No.: 14/283,527

(22) Filed: May 21, 2014

(51) Int. Cl. H04W 36/00; H04W 16/24

(52) U.S. Cl. CPC H04W 36/0083; H04W 16/24; H04W 84/045

(57) ABSTRACT

Methods, systems, and devices are described for mobility robustness optimization. A network may be organized into base station clusters, and mobility information may be exchanged within the cluster. Each base station may then receive statistics based on the collected information. In some examples the cluster mobility statistics are used to generate a handover transition matrix identifying a probability of a UE remaining with a target base station within the cluster for a threshold period following a handover from a source base station that is also within the cluster. Based on the cluster mobility statistics, the base station may determine that the probability of the UE remaining with the potential target base station for the threshold period is low. The base station may then select an alternative handover target. The base station may then adjust the mobility parameters of the UE in order to direct it to the alternative handover target.

### BACKGROUND

The following relates generally to wireless communication, and more specifically to mobility robustness optimization (MRO). Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple mobile devices or other user equipment (UE) devices. Base stations may communicate with UEs on downstream and upstream links. Each base station has a coverage range, which may be referred to as the coverage area of the cell. Base stations may be macro base stations with a large coverage area or small cells with a relatively small coverage area. A wireless network that contains both macro base stations and small cells may be referred to as a heterogeneous network.

Heterogeneous networks and small cell networks may experience unique challenges in helping UEs make smooth transitions from the coverage area of one base station to the coverage area of another base station. This process may be known as a handover. Specifically, handovers between small cells or between a small cell and a macro cell may experience a high rate of Handover Failure (HOF). This may occur because small cells may use the same frequency band as a macro base station and the average time-of-stay (ToS) in a small cell may be shorter than in a macro cell. The problem may be exacerbated when the UE is moving at a high speed from one coverage area to the next. UEs configured with a long discontinuous reception (DRX) cycle period may also experience high HOF rates, which may result in a disruption of data transfer between the UE and the network and a less satisfactory user experience.

### SUMMARY

The described features generally relate to one or more improved systems, methods, and/or apparatuses for mobility robustness optimization (MRO). A network may be organized into a number of base station clusters, and mobility information may be exchanged within the cluster. A base station in one of the clusters may then receive statistics based on the collected information. In some examples the cluster mobility statistics are used to generate a handover transition matrix identifying a probability of a user equipment (UE) remaining with a target base station within the cluster for a threshold period following a handover from a source base station that is also within the cluster. Based on the cluster mobility statistics, the base station may determine that the probability of the UE remaining with the potential target base station for the threshold period is low. The base station may then select an alternative handover target. The base station may then adjust the mobility parameters of the UE in order to direct it to the alternative handover target.

A method of mobility robustness optimization is described, the method comprising receiving, at a first base station in a cluster of base stations, cluster mobility statistics based on information gathered from each base station in the cluster of base stations, and adjusting at least one mobility parameter of a UE based on the cluster mobility statistics.

An apparatus for mobility robustness optimization is described, the apparatus comprising means for receiving, at a first base station in a cluster of base stations, cluster mobility statistics based on information gathered from each base station in the cluster of base stations, and means for adjusting at least one mobility parameter of a UE based on the cluster mobility statistics.

An apparatus for mobility robustness optimization is also described, comprising a processor, memory in electronic communication with the processor, and instructions stored in the memory, the instructions being executable by the processor to receive, at a first base station in a cluster of base stations, cluster mobility statistics based on information gathered from each base station in the cluster of base stations, and adjust at least one mobility parameter of a UE based on the cluster mobility statistics.

A computer program product for mobility robustness optimization is also described, the computer program product comprising a non-transitory computer-readable medium storing instructions executable by a processor to receive, at a first base station in a cluster of base stations, cluster mobility statistics based on information gathered from each base station in the cluster of base stations, and adjust at least one mobility parameter of a UE based on the cluster mobility statistics. Some examples comprise the cluster mobility statistics comprise a handover transition matrix identifying a probability of a UE remaining with a target base station of the cluster of base stations for a threshold period following a handover from a source base station of the cluster of base stations.

Some examples of the method, apparatuses, and/or computer program product described above may further comprise determining, based on the cluster mobility statistics, that the probability of the UE remaining with the target base station for the threshold period following the handover is lower than a threshold probability, and the adjusting of the at least one mobility parameter prevents or delays the handover of the UE to the target base station. In some examples selecting an alternative handover target based on the determination that the probability of the UE remaining with the target base station for the threshold period following the handover is lower than the threshold probability.

Some examples of the method, apparatuses, and/or computer program product described above may further comprise determining, based on the cluster mobility statistics, that the probability of the UE remaining with the target base station for the threshold period is greater than a threshold probability, and the adjusting of the at least one mobility parameter enables the handover of the UE to the target base station. In some examples the handover transition matrix comprises a split node based on path dependent handover probabilities.

In some examples of the method, apparatuses, and/or computer program product described above sending individual mobility statistics for the first base station to a coordinating unit. Some examples comprise the information gathered from each base station comprises at least one of time of stay (ToS) information, speed-dependent scaling information, handover failure rate information, UE specific handover patterns, or a handover pattern history.

In some examples of the method, apparatuses, and/or computer program product described above the cluster mobility statistics comprise a comparison of ToS data with a minimum time of stay (MTS) threshold. In some examples the cluster of base stations is formed based on handover probabilities.

In some examples of the method, apparatuses, and/or computer program product described above the cluster of base stations comprises at least three base stations. In some examples the cluster of base stations comprises at least one small cell.

In some examples of the method, apparatuses, and/or computer program product described above the at least one mobility parameter comprises at least one of a connected mode discontinuous reception (C-DRX) parameter, a hysteresis parameter, a time-to-trigger (TTT) parameter, an s-measure parameter, an event specific offset parameter, or a power adjustment setting parameter. Some examples comprise the UE adjusts its internal measurement period based on the C-DRX parameter.

In some examples of the method, apparatuses, and/or computer program product described above the mobility parameter is used by a second base station at the edge of the cluster of base stations to help a UE leave the cluster.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system in accordance with various embodiments;

FIG. 2 illustrates an example of a wireless communication system organized into clusters for mobility robustness optimization in accordance with various embodiments;

FIG. 3 illustrates an example of a wireless communication system for mobility robustness optimization in accordance with various embodiments;

FIG. 4 shows a block diagram of a device for mobility robustness optimization in accordance with various embodiments;

FIG. 5 shows a block diagram of a device for mobility robustness optimization in accordance with various embodiments;

FIG. 6 shows a block diagram of a device for mobility robustness optimization in accordance with various embodiments;

FIG. 7 illustrates a block diagram of a system for mobility robustness optimization in accordance with various embodiments;

FIG. 8 shows a flowchart illustrating a method for mobility robustness optimization in accordance with various embodiments.

FIG. 9 shows a flowchart illustrating a method for mobility robustness optimization in accordance with various embodiments.

FIG. 10 shows a flowchart illustrating a method for mobility robustness optimization in accordance with various embodiments.

### DETAILED DESCRIPTION

The described features generally relate to one or more improved systems, methods, and/or apparatuses for mobility robustness optimization (MRO). A network may be organized into a number of base station clusters, and mobility information may be exchanged within the cluster. A base station in one of the clusters may then receive statistics based on the collected information. In some examples the cluster mobility statistics are used to generate a handover transition matrix identifying a probability of a user equipment (UE) remaining with a target base station within the cluster for a threshold period following a handover from a source base station that is also within the cluster. Based on the cluster mobility statistics, the base station may determine that the probability of the UE remaining with the potential target base station for the threshold period is low. The base station may then select an alternative handover target. The base station may then adjust the mobility parameters of the UE in order to direct it to the alternative handover target.

Thus, the described systems, methods and/or apparatuses may reduce the probability that a UE will handover to a target for a small period of time before requiring another handover. This may reduce the number of unnecessary handovers and the probability of handover failure. This may be particularly effective when a UE is travelling at high speed through a network that includes small cells.

The following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

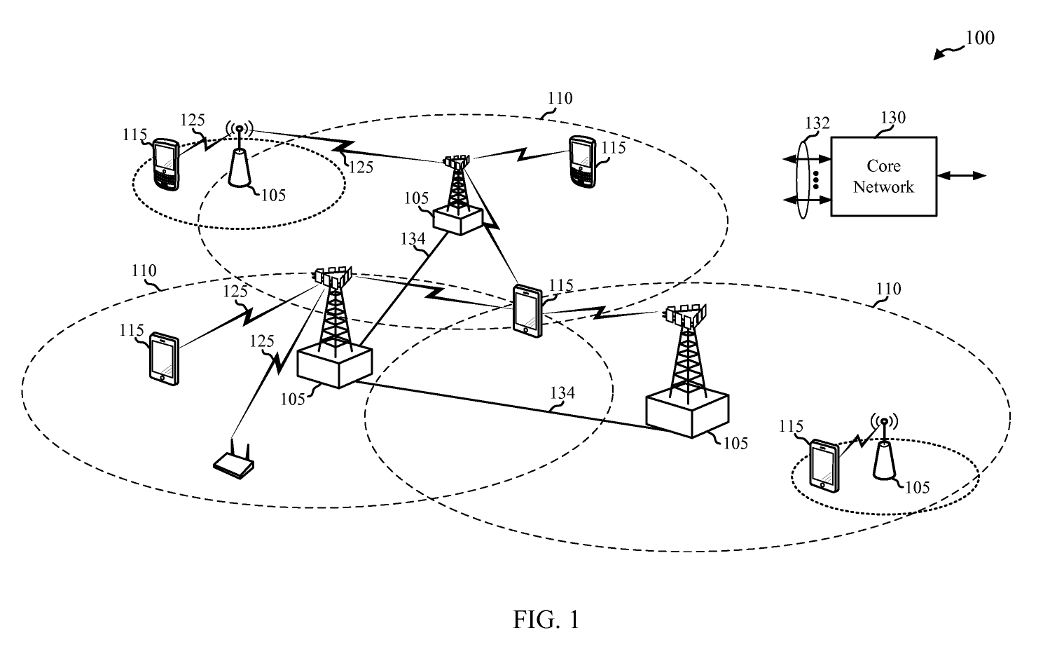

FIG. 1 illustrates an example of a wireless communications system 100 in accordance with various embodiments. The system 100 includes base stations 105, communication devices, also known as a user equipment (UEs) 115, and a core network 130. The base stations 105 may communicate with the UEs 115 under the control of a base station controller (not shown), which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134, which may be wired or wireless communication links. The system 100 may support operation on multiple carriers (waveform signals of different frequencies). Wireless communication links 125 may be modulated according to various radio technologies. Each modulated signal may carry control information (e.g., reference signals, control channels, etc.), overhead information, data, etc.

The base stations 105 may wirelessly communicate with the UEs 115 via one or more base station antennas. Each of the base station 105 sites may provide communication coverage for a respective coverage area 110. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown. The system 100 may include base stations 105 of different types (e.g., macro, micro, and/or pico base stations). There may be overlapping coverage areas for different technologies.

The system 100 may be a Heterogeneous LTE/LTE-A network in which different types of base stations provide coverage for various geographical regions. For example, each base station 105 may provide communication coverage for a macro cell, a small cell (aka, a pico cell or a femto cell) and/or other types of cells. A macro cell generally covers a relatively large geographic area (e.g., several kilometers in radius) and may allow unrestricted access by UEs with service subscriptions with the network provider. A small cell generally covers a relatively small geographic area (e.g., a home) and, in addition to unrestricted access, may also provide restricted access by UEs having an association with the small cell.

In a heterogeneous network, or a network that consists primarily of small cells, UEs 115 moving through the network may experience relatively frequent handovers. Furthermore, the likelihood of handover failure may be greater than in a homogenous network of macro cells. Thus, a heterogeneous or small cell network may be organized into clusters based on the frequency of handovers between cells within the network. Mobility statistics for each cluster may be generated based on information gathered from the constituent cells, and these statistics may be used to select the optimal handover target for UEs moving through the network.

The core network 130 may communicate with the base stations 105 via a backhaul link 132 (e.g., S1, etc.). The base stations 105 may also communicate with one another, e.g., directly or indirectly via backhaul links 134 (e.g., X2, etc.) and/or via backhaul links 132 (e.g., through core network 130). These backhaul communications may be used to gather mobility statistics within base station clusters. The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The UEs 115 may be dispersed throughout the wireless communications system 100, and each UE may be stationary or mobile. A UE 115 may be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communication links 125 shown in system 100 may include uplink (UL) transmissions from a UE 115 to a base station 105, and/or downlink (DL) transmissions, from a base station 105 to a UE 115 over DL carriers. The downlink transmissions may also be called forward link transmissions while the uplink transmissions may also be called reverse link transmissions.

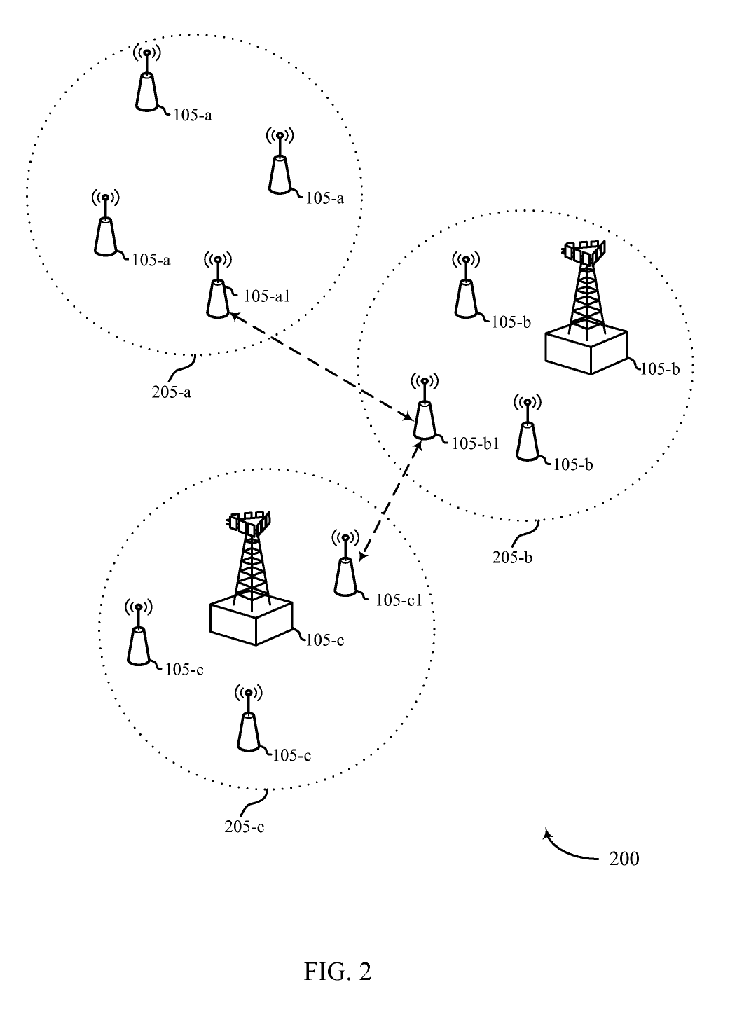

FIG. 2 illustrates an example of a wireless communication system 200 organized into clusters for mobility robustness optimization in accordance with various embodiments. Base stations 105-a may be grouped into cluster 205-a based on relatively frequent UE handovers between them. Similarly, base stations 105-b and 105-c may be grouped into cluster 205-b and 205-c respectively. In some examples the clusters 205 of base stations may be formed based on path-dependent handover probabilities. In some cases, clusters 205 may be organized such that each cluster 205 includes at least three base stations. In some cases a cluster 205 may consist exclusively of small cells, or may include some combination of small cells and macro cells.

Clusters 205 may be formed from the handover probabilities using a clustering algorithm such as a k-medoid, a k-means, seed based, distribution based, density based, single-linkage, complete linkage or an unweighted pair group method with arithmetic (UPGMA) algorithm. Other clustering algorithms may also be used. In some cases a cluster head or coordinating unit may be assigned within each cluster 205. The cluster head may be one of the base stations 105 within that cluster 205. The cluster head may gather the statistics from each base station 105 within the cluster and distribute the resulting cluster statistics among the base stations 105 of the cluster 205.

Information may be exchanged within each cluster and cluster statistics may be compiled relating to time of stay (ToS) information, speed-dependent scaling information, handover failure rate information, UE specific handover patterns, or handover pattern history. In some examples the cluster mobility statistics may include a comparison of ToS data with a minimum time of stay (MTS) threshold. ToS information and the MTS threshold may be used to detect and prevent ping-ponging between cells. That is, it may mitigate the problem of a UE repeatedly handing over from a first cell to a second cell and then back again based on temporary fluctuations in signal strength, small changes in location, and other related factors.

Coordination between base stations within the clusters may facilitate generation of ToS data, because when a UE successfully complete a handover it may send a handover (HO) complete message to the next cell. A ToS may be calculated by comparing the time stamp from the HO complete message a cell receives when the UE enters the cell with the HO complete message the next cell receives after the next handover.

The mobility statistics may include a handover transition matrix where each matrix element corresponds to the probability of a UE remaining with a target base station 105 for a threshold period following a handover from a source base station 105. For example, one index of the matrix element may correspond to the source cell and the other index of the matrix element may correspond to the target cell. For example, the probability that a UE will remain with a target station (AP_{P}) given source base station (AP_{K}) may be given by:

Prob(Sₙ₊₁=AP_{P}|Sₙ=AP_{P}&Sₙ₋₁=AP_{K}) (1)

where Sn represents the location of a UE at time period n. This probability may be associated with element (P, K) of the handover transition matrix. In some cases, each probability element may be compared to a threshold to determine whether a handover is likely to be successful. In some cases, handover probabilities may be based on path information that includes more than two base stations 105. For example, a probability may depend on the location of a UE prior to being handed over to the source base station 105.

In some examples the handover transition matrix may include split nodes based on path dependent handover probabilities. For example, if the probability or remaining with some receiving base station 105 (AP_{P}) as described above in Equation 1 is highly dependent on the source base station 105 (AP_{K}), the node AP_{P} may be split into two nodes, AP_{P} and AP_{P′}, which may correspond to different matrix indices.

In some cases, certain cells such as base station (e.g., 105-a1, 105-b1, and 105-c1) within a cluster 205 may be identified as boundary cells. A boundary cell may be a cell where it is likely that a UE travelling through the cell coverage area will move into the coverage area of a cell within a neighboring cluster (e.g., from 205-a to 205-b). In some cases a boundary small cell may maintain a connection with a UE moving toward another cluster 205-b rather than performing a handover to another cell within the cluster 205-a.

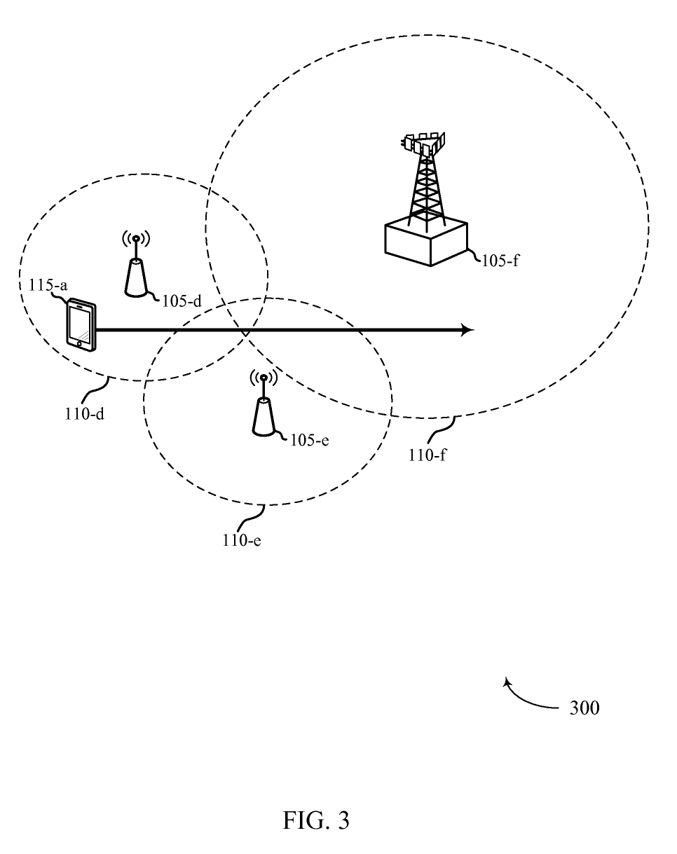

FIG. 3 illustrates an example of a wireless communication system 300 for mobility robustness optimization in accordance with various embodiments. A base station 105-d with coverage area 110-d may be in the same cluster as base station 105-e with coverage area 110-e. UE 115-a may be moving through the coverage area 110-d into coverage area 110-e. Base station 105-d may receive cluster mobility statistics and, based on these statistics, determine that there is a low probability that UE 155-a will remain with base station 105-e for a threshold period of time. For example, UE 115-a may be travelling at a high speed toward another base station 105-f with coverage area 110-f. Base station 105-f may be within the same cluster as base station 105-d or in a different cluster. In one example, base station 105-d may be a boundary station between two different clusters.

Base station 105-d may then select an alternative handover target based on the determination that the probability of UE 115-a staying within coverage area 110-e is below the threshold. For example, base station 105-f may be the alternative handover target. Base station 105-d may then adjust at least one mobility parameter of UE 15-a to increase the likelihood that UE 115-a will handover to base station 105-f and/or decrease the likelihood that it will handover to base station 105-e.

The adjusted mobility parameter may include a connected mode discontinuous reception (C-DRX) parameter, a hysteresis parameter, a time-to-trigger (TTT) parameter, an s-measure parameter, an event specific offset parameter, or a power adjustment setting parameter. In some examples the UE 115-a may adjust a parameter based on an indication from base station 105-d and/or a UE specific handover history. For example, UE 115-a may adjust an internal measurement period based on the C-DRX parameter. In some examples the adjusted mobility parameter may be used by any base station 105 at the edge of the cluster to help UE 115-a leave the cluster without a service disruption. For example, it may reduce the likelihood of ping-ponging between cells within the cluster.

One example of a method to adjust a mobility parameter may be to apply a small cell scaling factor, or femto weight, (e.g., 0.5) to the current measurement cycle (intra_meas_periodicity), if the UE 115 determines that there is an urgent handover:

intra_meas_periodicity=femto_wt·min(A·cdrx_cycle,B ms) (2)

where parameters A and B may be defined independently according to different modes.

Speed-dependent scaling may also be used to enable the UE 115-a to adjust the parameters adaptively. In some cases, one or both of the small cell base station 105-d and the UE 115-a can apply mobility robustness optimization adjustments in a cell-specific manner based on average performance statistics in the cell and/or UE specific history.

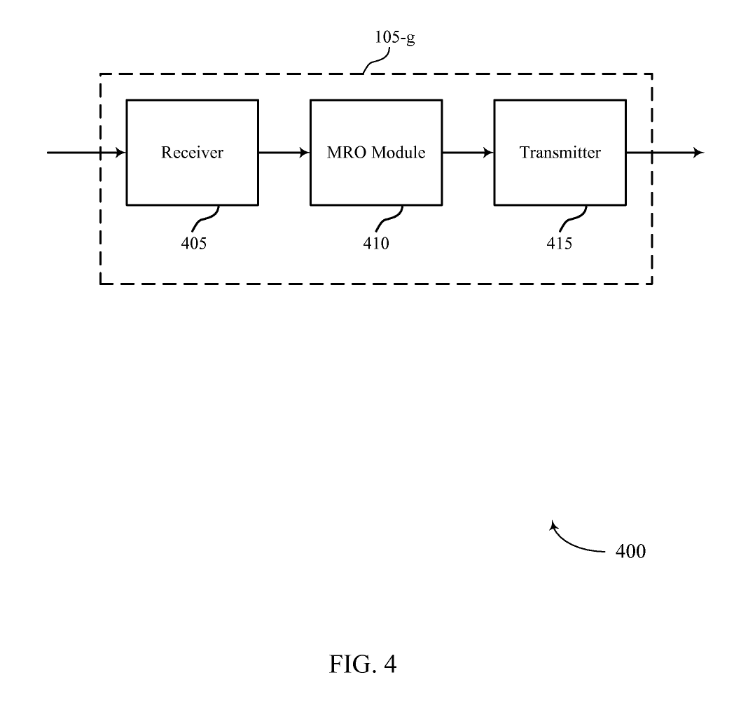

FIG. 4 shows a block diagram 400 of a base station 105-g for mobility robustness optimization in accordance with various embodiments. The base station 105-g may be an example of one or more aspects of a base station 105 described with reference to FIGS. 1-3. The base station 105-g may include a receiver 405, a MRO module 410, and/or a transmitter 415. The base station 105-g may also include a processor. Each of these components may be in communication with each other.

The components of the base station 105-g may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver 405 may receive information such as packets, user data, and/or control information associated with various information channels (e.g., control channels, data channels, etc.). Information may be passed on to the MRO module 410, and to other components of the base station 105-g (not shown).

The MRO module 410 may be configured to receive (in coordination with the receiver 405) cluster mobility statistics based on information gathered from each base station 105 in a cluster 205 of base stations 105. The MRO module 410 may also be configured to adjust at least one mobility parameter of a UE based on the cluster mobility statistics.

The transmitter 415 may transmit data or signals received from the other components of the base station 105-g. In some embodiments, the transmitter 415 may be collocated with the receiver 405 in a transceiver module. The transmitter 415 may include a single antenna, or a plurality of antennas.

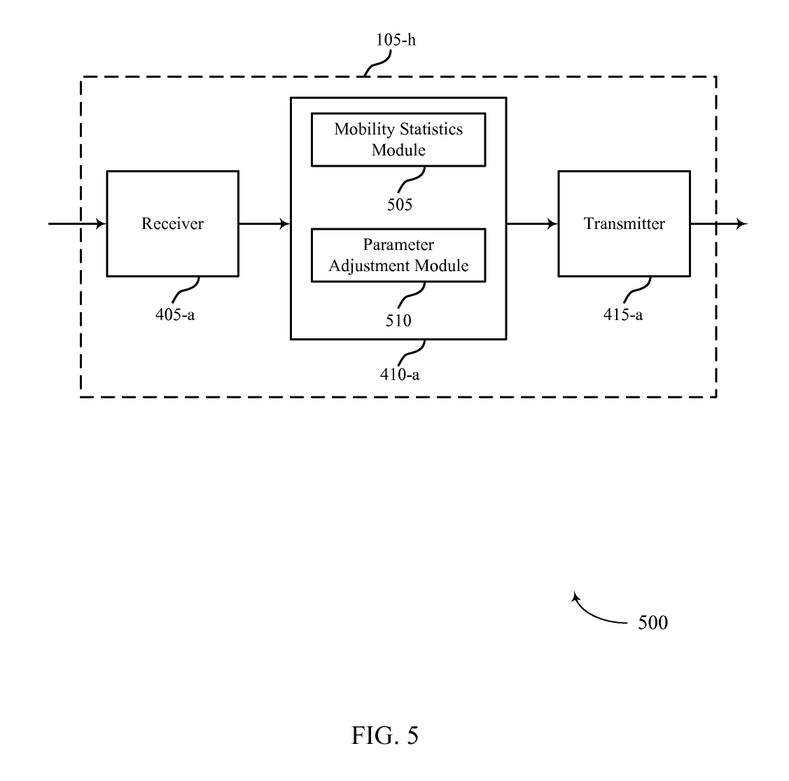

FIG. 5 shows a block diagram 500 of a base station 105-h for mobility robustness optimization in accordance with various embodiments. The base station 105 may be an example of one or more aspects of a base station 105 described with reference to FIGS. 1-4. The base station 105-h may include a receiver 405-a, a MRO module 410-a, and/or a transmitter 415-a. The base station 105-h may also include a processor. Each of these components may be in communication with each other. The MRO module 410-a may also include a mobility statistics module 505, and a parameter adjustment module 510.

The components of the base station 105-h may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver 405-a may receive information which may be passed on to the MRO module 410-a, and to other components of the base station 105. The MRO module 410-a may be configured to perform the operations described above with reference to FIG. 4. The transmitter 415-a may transmit the one or more signals received from other components of the base station 105-h.

The mobility statistics module 505 may be configured to receive, at the first base station 105-h in a cluster of base stations, cluster mobility statistics based on information gathered from each base station 105 in the cluster 205 of base stations 105. The mobility statistics module 505 may also be configured to send individual mobility statistics for the first base station 105-h to a coordinating unit. In some examples, the information gathered from each base station 105 comprises at least one of ToS information, speed-dependent scaling information, handover failure rate information, UE specific handover patterns, or a handover pattern history. In some examples, the cluster mobility statistics comprise a comparison of ToS data with an MTS threshold. In some examples, the cluster 205 of base stations 105 is formed based on handover probabilities. In some examples, the cluster 205 of base stations 105 comprises at least three base stations 105. In some examples, the cluster 205 of base stations 105 comprises at least one small cell base station 105.

The parameter adjustment module 510 may also be configured to adjust at least one mobility parameter of a UE 115 based on the cluster mobility statistics. In some examples, the at least one mobility parameter comprises at least one of a C-DRX parameter, a hysteresis parameter, a TTT parameter, an s-measure parameter, an event specific offset parameter, or a power adjustment setting parameter. In some examples, the UE 115 adjusts its internal measurement period based on the C-DRX parameter.

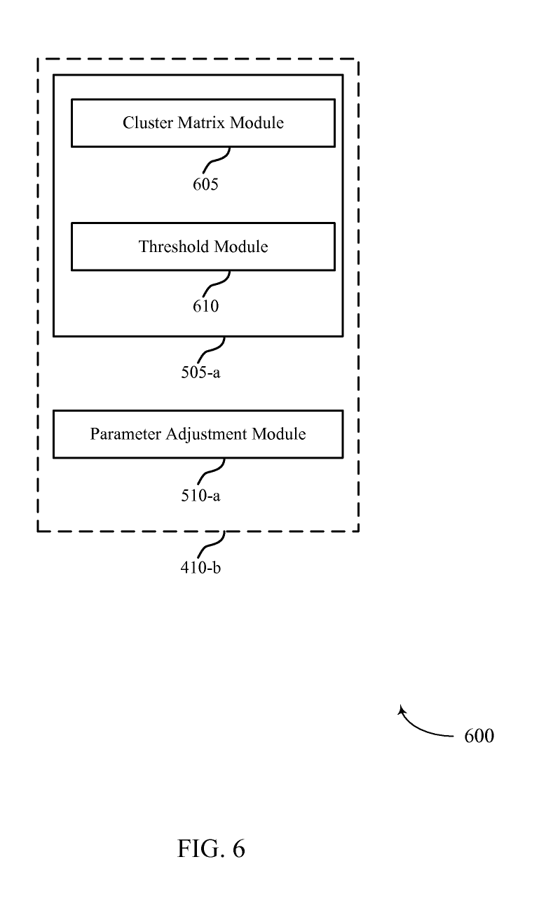

FIG. 6 shows a block diagram 600 of a MRO module 410-b for mobility robustness optimization in accordance with various embodiments. The MRO module 410-b may be an example of one or more aspects of a MRO module 410 described with reference to FIGS. 4-5. The MRO module 410-b may include a mobility statistics module 505-a, and a parameter adjustment module 510-a. Each of these modules may perform the functions described above with reference to FIG. 5. The mobility statistics module 505-a may also include a cluster matrix module 605, and a threshold module 610.

The components of the MRO module 410-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The cluster matrix module may be configured to generate and/or receive a matrix of handover probabilities. For example, the received cluster mobility statistics comprise the handover transition matrix identifying a probability of a UE 115 remaining with a target base station 105 of the cluster 205 of base stations 105 for a threshold period following a handover from a source base station 105 of the cluster 205 of base stations 105. In some examples, the handover transition matrix comprises a split node based on path dependent handover probabilities.

The threshold module 610 may also be configured to determine, based on the cluster mobility statistics, that the probability of the UE 115 remaining with the target base station for the threshold period following the handover is lower than a threshold probability. The threshold module 610 may also be configured to determine, based on the cluster mobility statistics, that the probability of the UE remaining with the target base station for the threshold period is greater than a threshold probability. The threshold module 610 may also be configured to select an alternative handover target based on the determination that the probability of the UE 115 remaining with the target base station for the threshold period following the handover is lower than the threshold probability. The selection of a handover target may be done in coordination with a handover module (not shown).

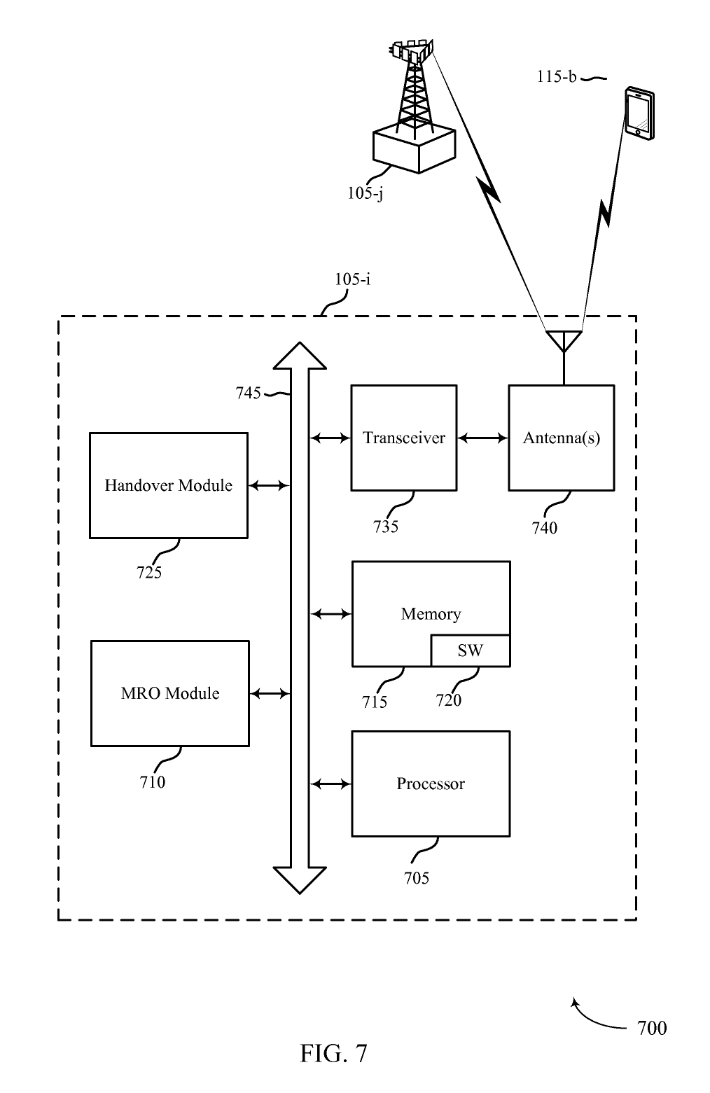

FIG. 7 shows a diagram of a system 700 for mobility robustness optimization in accordance with various embodiments. System 700 may include a base station 105-i, which may be an example of an base station 105 with reference to FIGS. 1-6. The base station 105-i may generally include components for bi-directional voice and data communications including components for transmitting communications and components for receiving communications.

The base station 105 may include antenna(s) 740, a transceiver module 735, a processor module 705, memory 715 (including software (SW)) 720, an MRO module 410-c, and a handover module, which each may communicate, directly or indirectly, with each other (e.g., via one or more buses 745). The transceiver module 735 may be configured to communicate bi-directionally, via the antenna(s) 740 and/or one or more wired or wireless links, with one or more networks, as described above. For example, the transceiver module 735 may be configured to communicate bi-directionally with a base station 105. The transceiver module 735 may include a modem configured to modulate the packets and provide the modulated packets to the antenna(s) 740 for transmission, and to demodulate packets received from the antenna(s) 740. While the base station 105 may include a single antenna 740, the base station 105 may also have multiple antennas 740 capable of concurrently transmitting and/or receiving multiple wireless transmissions. The transceiver module 735 may also be capable of concurrently communicating with one or more base stations 105.

The memory 715 may include random access memory (RAM) and read-only memory (ROM). The memory 715 may store computer-readable, computer-executable software/firmware code 720 containing instructions that are configured to, when executed, cause the processor module 705 to perform various functions described herein (e.g., call processing, database management, processing of carrier mode indicators, reporting CSI, etc.). Alternatively, the software/firmware code 720 may not be directly executable by the processor module 705 but be configured to cause a computer (e.g., when compiled and executed) to perform functions described herein. The processor module 705 may include an intelligent hardware device, e.g., a central processing unit (CPU), a microcontroller, an application-specific integrated circuit (ASIC), etc. may include random access memory (RAM) and read-only memory (ROM). The memory 715 may store computer-readable, computer-executable software/firmware code 720 containing instructions that are configured to, when executed, cause the processor module 705 to perform various functions described herein (e.g., call processing, database management, processing of carrier mode indicators, reporting CSI, etc.). Alternatively, the software/firmware code 720 may not be directly executable by the processor module 705 but be configured to cause a computer (e.g., when compiled and executed) to perform functions described herein. The processor module 705 may include an intelligent hardware device, e.g., a central processing unit (CPU), a microcontroller, an application-specific integrated circuit (ASIC), etc.

The MRO module 410-c may be an example of one or more of the MRO modules 410 described above with reference to FIGS. 4-7. As such, the MRO module 410-c may be configured to receive (in coordination with the transceiver 735) cluster mobility statistics based on information gathered from each base station 105 in a cluster 205 of base stations 105. The MRO module 410-c may also be configured to adjust at least one mobility parameter of a UE based on the cluster mobility statistics.

The handover module 725 may be configured to select an alternative handover target based on the determination that the probability of the UE 115 remaining with the target base station for the threshold period following the handover is lower than the threshold probability. The selection of a handover target may be done in coordination with a threshold module (not shown). In some examples, the adjusting of the at least one mobility parameter enables the handover of the UE 115 to a target base station 105. In some examples, the mobility parameter is used by a second base station 105 at the edge of the cluster of base stations to help a UE 115 leave the cluster. In some examples, the adjusting of the at least one mobility parameter prevents or delays the handover of the UE 115 to a target base station 105.

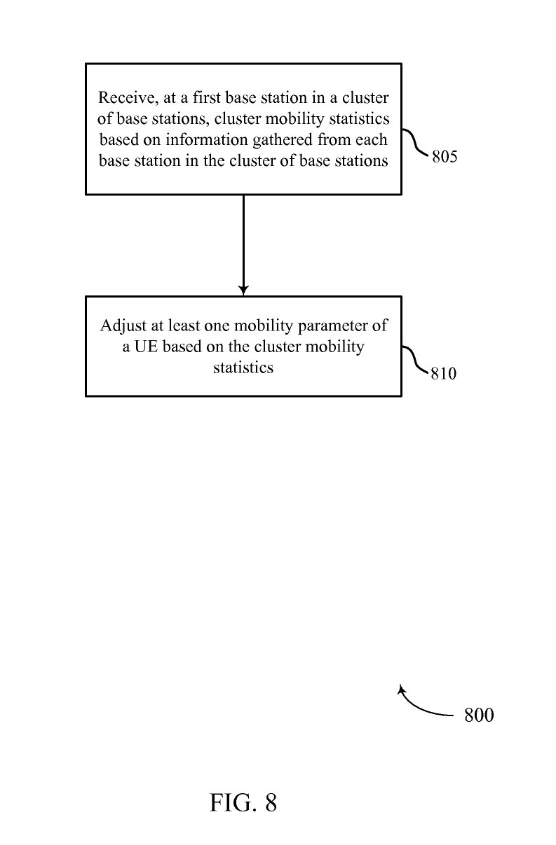

FIG. 8 shows a flowchart 800 illustrating a method for mobility robustness optimization in accordance with various embodiments. The functions of flowchart 800 may be implemented by a base station 105 or its components as described with reference to FIGS. 1-7. In certain examples, the blocks of the flowchart 800 may be performed by the MRO module 410 with reference to FIGS. 4-7.

At block 805, a first base station in a cluster of base stations may receive cluster mobility statistics based on information gathered from each base station in the cluster of base stations. Cluster statistics may be compiled relating to ToS information, speed-dependent scaling information, handover failure rate information, UE specific handover patterns, or handover pattern history. In some examples the cluster mobility statistics may include a comparison of ToS data with a MTS threshold. The cluster statistics may include a matrix of handover failure probabilities. In certain examples, the functions of block 805 may be performed by the mobility statistics module 505 as described above with reference to FIGS. 5-6.

At block 810, the base station 105 may adjust at least one mobility parameter of a UE based on the cluster mobility statistics. In some examples the at least one mobility parameter comprises at least one of a C-DRX parameter, a hysteresis parameter, a TTT parameter, an s-measure parameter, an event specific offset parameter, or a power adjustment setting parameter. In certain examples, the functions of block 810 may be performed by the parameter adjustment module 510 as described above with reference to FIGS. 5-6.

It should be noted that the method of flowchart 800 is just one implementation and that the operations of the method, and the steps may be rearranged or otherwise modified such that other implementations are possible.

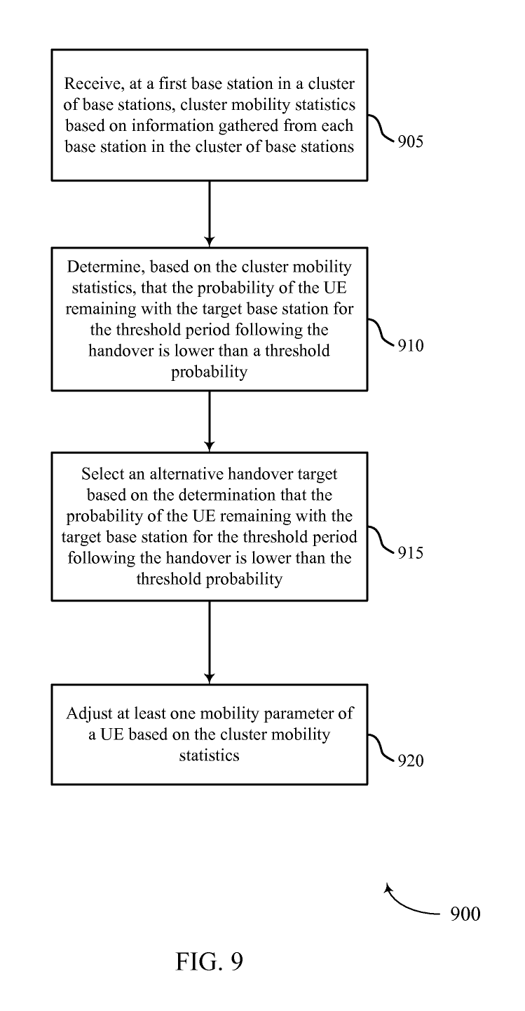

FIG. 9 shows a flowchart 900 illustrating a method for mobility robustness optimization in accordance with various embodiments. The functions of flowchart 900 may be implemented by a base station 105 or its components as described with reference to FIGS. 1-7. In certain examples, the blocks of the flowchart 900 may be performed by the MRO module 410 with reference to FIGS. 4-7. The method described in flowchart 900 may also incorporate aspects of flowchart 800 of FIG. 8.

At block 905, a first base station 105 in a cluster 205 of base stations may receive cluster mobility statistics based on information gathered from each base station 105 in the cluster 205. Cluster statistics may be compiled relating to ToS information, speed-dependent scaling information, handover failure rate information, UE specific handover patterns, or handover pattern history. In some examples the cluster mobility statistics may include a comparison of ToS data with a MTS threshold. The cluster statistics may include a matrix of handover failure probabilities. In certain examples, the functions of block 905 may be performed by the mobility statistics module 505 as described above with reference to FIG. 5.

At block 910, the base station 105 may determine, based on the cluster mobility statistics, that the probability of the UE remaining with the target base station 105 for the threshold period following the handover is lower than a threshold probability. In certain examples, the functions of block 910 may be performed by the threshold module 610 as described above with reference to FIG. 6.

At block 915, the base station 105 may select an alternative handover target based on the determination that the probability of the UE 115 remaining with the target base station 105 for the threshold period following the handover is lower than the threshold probability. In certain examples, the functions of block 915 may be performed by the threshold module 610 as described above with reference to FIG. 6.

At block 920, the base station 105 may adjust at least one mobility parameter of a UE 115 based on the cluster mobility statistics. In some examples the at least one mobility parameter comprises at least one of a C-DRX parameter, a hysteresis parameter, a TTT parameter, an s-measure parameter, an event specific offset parameter, or a power adjustment setting parameter. In certain examples, the functions of block 920 may be performed by the parameter adjustment module 510 as described above with reference to FIG. 5.

It should be noted that the method of flowchart 900 is just one implementation and that the operations of the method, and the steps may be rearranged or otherwise modified such that other implementations are possible.

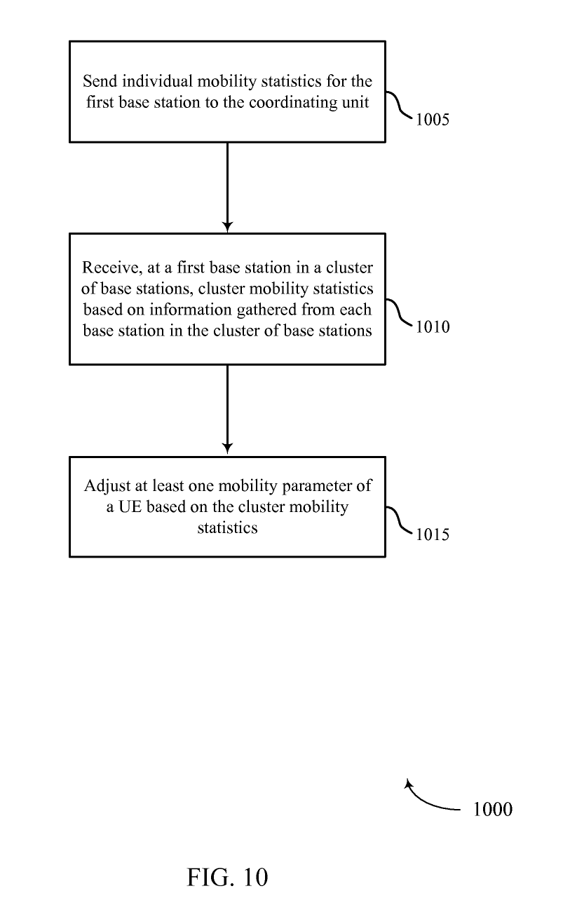

FIG. 10 shows a flowchart 1000 illustrating a method for mobility robustness optimization in accordance with various embodiments. The functions of flowchart 1000 may be implemented by a base station 105 or its components as described with reference to FIGS. 1-10. In certain examples, the blocks of the flowchart 1000 may be performed by the MRO module 410 with reference to FIGS. 4-7. The method described in flowchart 1000 may also incorporate aspects of flowcharts 800 to 900 of FIGS. 8-9.

At block 1005, the base station 105 may send individual mobility statistics to a coordinating unit. Information may be sent relating to ToS information, speed-dependent scaling information, handover failure rate information, UE specific handover patterns, or handover pattern history. In some examples the cluster mobility statistics may include a comparison of ToS data with a MTS threshold. The cluster statistics may include a matrix of handover failure probabilities. In certain examples, the functions of block 1005 may be performed by the mobility statistics module 505 as described above with reference to FIG. 5.

At block 1010, the first base station 105 in the cluster 205 of base stations may receive cluster mobility statistics based on information gathered from each base station 105 in the cluster 205 of base stations. In certain examples, the functions of block 1010 may be performed by the mobility statistics module 505 as described above with reference to FIG. 5.

At block 1015, the base station 105 may adjust at least one mobility parameter of a UE 115 based on the cluster mobility statistics. In some examples the at least one mobility parameter comprises at least one of a C-DRX parameter, a hysteresis parameter, a TTT parameter, an s-measure parameter, an event specific offset parameter, or a power adjustment setting parameter. In certain examples, the functions of block 1015 may be performed by the parameter adjustment module 510 as described above with reference to FIG. 5.

It should be noted that the method of flowchart 1000 is just one implementation and that the operations of the method, and the steps may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, ‘or’ as used in a list of items (for example, a list of items prefaced by a phrase such as ‘at least one of’ or ‘one or more of’) indicates a disjunctive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term ‘example’ or ‘exemplary’ indicates an example or instance and does not imply or require any preference for the noted example. Thus, the disclosure is not to be limited to the examples and designs described herein but is to be accorded the widest scope consistent with the principles and novel features disclosed herein.

Techniques described herein may be used for various wireless communications systems such as CDMA, TDMA, FDMA, OFDMA, SC-FDMA, and other systems. The terms ‘system’ and ‘network’ are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named ‘3rd Generation Partnership Project’ (3GPP). CDMA2000 and UMB are described in documents from an organization named ‘3rd Generation Partnership Project 2’ (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of mobility robustness optimization, comprising:
receiving, at a first base station in a cluster of base stations, cluster mobility statistics based on information gathered from each base station in the cluster of base stations; and
adjusting at least one mobility parameter of a UE based on the cluster mobility statistics.

2. The method of claim 1, wherein the cluster mobility statistics comprise a handover transition matrix identifying a probability of the UE remaining with a target base station of the cluster of base stations for a threshold period following a handover from a source base station of the cluster of base stations.

3. The method of claim 2, further comprising:
determining, based on the cluster mobility statistics, that the probability of the UE remaining with the target base station for the threshold period following the handover is lower than a threshold probability; and
selecting an alternative handover target based on the determination that the probability of the UE remaining with the target base station for the threshold period following the handover is lower than the threshold probability.

4. The method of claim 2, further comprising:
determining, based on the cluster mobility statistics, that the probability of the UE remaining with the target base station for the threshold period is greater than a threshold probability.

5. The method of claim 2, wherein the handover transition matrix comprises a split node based on path dependent handover probabilities.

6. The method of claim 1, further comprising:
sending individual mobility statistics for the first base station to a coordinating unit.

7. The method of claim 1, wherein the information gathered from each base station comprises at least one of time of stay (ToS) information, speed-dependent scaling information, handover failure rate information, UE specific handover patterns, or a handover pattern history.

8. The method of claim 7, wherein the cluster mobility statistics comprise a comparison of ToS data with a minimum time of stay (MTS) threshold.

9. The method of claim 1, wherein the cluster of base stations is formed based on handover probabilities.

10. The method of claim 1, wherein the cluster of base stations comprises at least three base stations or at least one small cell.

11. The method of claim 1, wherein the at least one mobility parameter comprises at least one of a connected mode discontinuous reception (C-DRX) parameter, a hysteresis parameter, a time-to-trigger (TTT) parameter, an s-measure parameter, an event specific offset parameter, or a power adjustment setting parameter.

12. The method of claim 11, wherein the UE adjusts its internal measurement period based on the C-DRX parameter.

13. The method of claim 1, wherein the adjusting of the at least one mobility parameter enables a handover of the UE to a target base station.

14. The method of claim 13, wherein the at least one mobility parameter is used by a second base station at an edge of the cluster of base stations to help a UE leave the cluster.

15. The method of claim 1, wherein the adjusting of the at least one mobility parameter prevents or delays a handover of the UE to a target base station.

16. An apparatus for mobility robustness optimization, comprising:
means for receiving, at a first base station in a cluster of base stations, cluster mobility statistics based on information gathered from each base station in the cluster of base stations; and
means for adjusting at least one mobility parameter of a UE based on the cluster mobility statistics.

17. The apparatus of claim 16, wherein the cluster mobility statistics comprise a handover transition matrix identifying a probability of the UE remaining with a target base station of the cluster of base stations for a threshold period following a handover from a source base station of the cluster of base stations.

18. The apparatus of claim 17, further comprising:
means for determining, based on the cluster mobility statistics, that the probability of the UE remaining with the target base station for the threshold period following the handover is lower than a threshold probability; and
means for selecting an alternative handover target based on the determination that the probability of the UE remaining with the target base station for the threshold period following the handover is lower than the threshold probability.

19. The apparatus of claim 17, further comprising:
means for determining, based on the cluster mobility statistics, that the probability of the UE remaining with the target base station for the threshold period is greater than a threshold probability.

20. The apparatus of claim 16, wherein the information gathered from each base station comprises at least one of ToS information, speed-dependent scaling information, handover failure rate information, UE specific handover patterns, or a handover pattern history.

21. The apparatus of claim 20, wherein the cluster mobility statistics comprise a comparison of ToS data with an MTS threshold.

22. The apparatus of claim 16, wherein the at least one mobility parameter comprises at least one of a C-DRX parameter, a hysteresis parameter, a TTT parameter, an s-measure parameter, an event specific offset parameter, or a power adjustment setting parameter.

23. An apparatus for mobility robustness optimization, comprising:
a processor;
memory in electronic communication with the processor; and
instructions stored in the memory, the instructions being executable by the processor to:
receive, at a first base station in a cluster of base stations, cluster mobility statistics based on information gathered from each base station in the cluster of base stations; and
adjust at least one mobility parameter of a UE based on the cluster mobility statistics.

24. The apparatus of claim 23, wherein the cluster mobility statistics comprise a handover transition matrix identifying a probability of a UE remaining with a target base station of the cluster of base stations for a threshold period following a handover from a source base station of the cluster of base stations.

25. The apparatus of claim 24, the instructions being further executable by the processor to:
determine, based on the cluster mobility statistics, that the probability of the UE remaining with the target base station for the threshold period following the handover is lower than a threshold probability; and
select an alternative handover target based on the determination that the probability of the UE remaining with the target base station for the threshold period following the handover is lower than the threshold probability.

26. The apparatus of claim 24, the instructions being further executable by the processor to:
determine, based on the cluster mobility statistics, that the probability of the UE remaining with the target base station for the threshold period is greater than a threshold probability.

27. The apparatus of claim 23, wherein the information gathered from each base station comprises at least one of ToS information, speed-dependent scaling information, handover failure rate information, UE specific handover patterns, or a handover pattern history.

28. The apparatus of claim 27, wherein the cluster mobility statistics comprise a comparison of ToS data with an MTS threshold.

29. The apparatus of claim 23, wherein the at least one mobility parameter comprises at least one of a C-DRX parameter, a hysteresis parameter, a TTT parameter, an s-measure parameter, an event specific offset parameter, or a power adjustment setting parameter.

30. A computer program product for mobility robustness optimization, the computer program product comprising a non-transitory computer-readable medium storing instructions executable by a processor to:
receive, at a first base station in a cluster of base stations, cluster mobility statistics based on information gathered from each base station in the cluster of base stations; and
adjust at least one mobility parameter of a UE based on the cluster mobility statistics.
